(19) United States
(12) Patent Application Publication
(10) Pub. No.: US 2015/0260627 A1
(43) Pub. Date: Sep. 17, 2015

(54) FIBER CONTENT ANALYSIS METHOD AND SYSTEM

(71) Applicant: Schlumberger Technology Corporation, Sugar Land, TX (US)

(72) Inventors: Timothy Lesko, Conway, AR (US); Jeremy Weldon, Conway, AR (US)

(73) Assignee: SCHLUMBERGER TECHNOLOGY CORPORATION, Sugar Land, TX (US)

(21) Appl. No.: 14/204,790

(22) Filed: Mar. 11, 2014

(51) Int. Cl. G01N 11/14

(52) U.S. Cl. CPC G01N 11/14

(57) ABSTRACT

A method to determine fiber content of a fluid specimen involving measuring an initial torque development characteristic of the fluid specimen at specified conditions; and comparing the measured initial torque development characteristic of the specimen to initial torque development characteristics of control fluids of known fiber content at the specified conditions to estimate the fiber content of the fluid specimen. Also disclosed is a system to determine fiber content of a fluid specimen, involving a rheometer to measure the initial torque development characteristic of the fluid specimen at specified conditions; and a database of yield points of control fluids of known fiber content at the specified conditions for comparison with the measured yield point to estimate the fiber content of the fluid specimen.

### BACKGROUND

The statements in this section merely provide background information related to the present disclosure and may not constitute prior art.

It is a well-documented phenomenon that when fibers are added to a base fluid that the viscosity of the slurry visually appears to increase. However, because such fluids exhibit transient, time-dependent rheology, past attempts to characterize fiber concentration by using Couette type rheometers (e.g., bob and rotor style rheometers such as the FANN 35, FANN 50, CHANDLER 3500, CHANDLER 5550) fail to produce any useable result.

FIG. 1 demonstrates the behavior that is typical of a fiber-laden, guar-thickened slurry that is measured with a Couette-style rheometer. At 300 RPM (shear rate: 511 sec⁻¹) with an R1 rotor, B1 bob and F1 spring configuration (R1B1F1), the rheometer gives a reading of 18 mPa-sec. As fibers are added to the guar fluid, the fluid visibly thickens. Despite the fiber concentration increasing from 0 to 12 g/L (100 ppt, or 100 pounds of fiber per 1000 gallons of clean fluid), there is hardly any response in the instrument. Based on visual appearance, the viscosity would be expected to rise by hundreds of mPa-sec; however, from 0 to 6 g/L (50 ppt) there is only a slight increase in viscosity of 3 mPa-sec, which is hardly remarkable and gives little to no indication in any significant change in rheology. As the fiber concentration increases, the viscosity seen with the rheometer decreases back to the baseline conditions, and it is difficult or impossible to determine fiber content from such data.

Other methods of measuring the fiber content of slurries may use a mass balance technique or filtration with dry weight measurement. The mass balance approach involves ratioing the amount or rate of fiber added to an amount or rate of fluid, and does not account for instantaneous fluctuations, improper mixing or dispersion, post-mixing phase separation, agglomeration, or the like. The filtration technique involves filtration of fibers from a known volume of fluid, and washing, drying and weighing the filtrate. In the context of a well stimulation environment, none of these methods provides a reliable, fast and easy method of determining fiber concentrations in the well stimulation fluid. Accordingly, there is a need for procedures and systems to determine fiber content in a viscous fluid.

### SUMMARY

The rheological behavior of fiber-laden fluids is attributed in some embodiments herein, to the yield stress and apparent progression of alignment of the fibers in the fluid as it passes through the narrow gap between the bob and rotor. The fluid in the rheometer initially exhibits a short period of generally linear development of torque versus time proportional to fiber content, upon initiation of shear from a state of rest, which upon nearing or reaching the yield point of the fluid, is followed by a short period of apparent thixotropy—time dependent shear thinning—shortly thereafter, so that simple rheometer readings do not correlate well with fiber content.

According to some embodiments of the present disclosure, a method to determine fiber content of a fluid specimen comprises measuring an initial torque development characteristic of the fluid specimen at specified conditions; and comparing the measured initial torque development characteristic of the specimen to initial torque development characteristic of control fluids of known fiber content at the specified conditions to estimate the fiber content of the fluid specimen. In some embodiments, the initial torque development characteristic is selected from the shape of the torque vs. time curve (including best fit equations and/or coefficients), the slope of the torque vs. time curve, e.g., at a specified time such as 5 or 10 seconds after initiation or the average slope over a range of time such as from 3 seconds to 10 seconds, yield point, maximum torque, and so on, or a combination thereof. In some embodiments, the specified conditions comprise initiating torque development from rest, and the same temperature, test apparatus and testing protocol used for testing the control fluids.

According to some embodiments of the present disclosure, a method to determine fiber content of a fluid specimen comprises measuring an initial torque development characteristic of a plurality of control fluids of known fiber content on a rheometer at specified conditions; measuring the initial torque development characteristic of the fluid specimen at the specified conditions; and comparing the measured initial torque development characteristic of the specimen to the measured initial torque development characteristics of the plurality of control fluids to estimate the fiber content of the fluid specimen.

According to some embodiments, a system to determine fiber content of a fluid specimen comprises a rheometer to measure an initial torque development characteristic of the fluid specimen at specified conditions; and a database of initial torque development characteristics of control fluids of known fiber content at the specified conditions for comparison with the measured yield point to estimate the fiber content of the fluid specimen.

### BRIEF DESCRIPTION OF THE DRAWINGS

These and other features and advantages will be better understood by reference to the following detailed description when considered in conjunction with the accompanying drawings.

FIG. 1 (prior art) shows rheological behavior of a fiber-laden slurry in a Couette-style rheometer (CHANDLER 3500) according to Example 1 (Comparative).

FIG. 2 shows a schematic flow diagram of a fiber content analysis according to embodiments of the present disclosure.

FIG. 3 shows the torque-time relationship of a fiber-containing linear gel system of Example 2 according to some embodiments of the current application.

FIG. 4 shows the torque-time relationship of a fiber-containing decrosslinked gel system of Example 3 according to some embodiments of the current application.

FIG. 5 shows the torque-time relationship of a treatment fluid containing varying amounts of fiber according to some embodiments of the current application.

FIG. 6 plots a best-fit curve of the 10-second torque versus the fiber concentration in a treatment fluid according to some embodiments of the current application.

FIG. 7 compares the torque-time relationship of different treatment fluid test samples to that of a reference sample according to some embodiments of the current application.

FIG. 8 compares the torque-time relationship of different treatment fluid test samples of unknown fiber content to that of reference samples of known fiber content according to some embodiments of the current application.

### DETAILED DESCRIPTION OF SOME ILLUSTRATIVE EMBODIMENTS

For the purposes of promoting an understanding of the principles of the disclosure, reference will now be made to some illustrative embodiments of the current application. Like reference numerals used herein refer to like parts in the various drawings. Reference numerals without suffixed letters refer to the part(s) in general; reference numerals with suffixed letters refer to a specific one of the parts.

As used herein, “embodiments” refers to non-limiting examples of the application disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Moreover, the schematic illustrations and descriptions provided herein are understood to be examples only, and components and operations may be combined or divided, and added or removed, as well as re-ordered in whole or part, unless stated explicitly to the contrary herein. Certain operations illustrated may be implemented by a computer executing a computer program product on a computer readable medium, where the computer program product comprises instructions causing the computer to execute one or more of the operations, or to issue commands to other devices to execute one or more of the operations.

It should be understood that, although a substantial portion of the following detailed description may be provided in the context of oilfield treatment fluids, e.g., fracturing fluids, other oilfield and non-oilfield well treatment operations can utilize and benefit as well from the instant disclosure.

In some embodiments, a method to determine fiber content of a fluid specimen comprises measuring an initial torque development characteristic of the fluid specimen at specified conditions; and comparing the measured initial torque development characteristic of the specimen to initial torque development characteristics of control fluids of known fiber content at the specified conditions to estimate the fiber content of the fluid specimen.

In some embodiments, a method to determine fiber content of a fluid specimen may comprise measuring initial torque development characteristics of a plurality of control fluids of known fiber content on a rheometer at specified conditions; measuring the initial torque development characteristic of the fluid specimen at the specified conditions; and comparing the measured initial torque development characteristic of the specimen to the measured initial torque development characteristics of the control fluids to estimate the fiber content of the fluid specimen.

In some embodiments, a method to determine fiber content of a fluid specimen may comprise measuring an initial torque development characteristic, of at least one control fluid having a target fiber content, on a rheometer at specified conditions; mixing a base fluid with a sufficient proportion of the fiber for obtaining a mixture with the target fiber content; sampling the mixture to obtain the fluid specimen; measuring the initial torque development characteristic of the fluid specimen at the specified conditions; and comparing the measured initial torque development characteristic of the specimen to the measured initial torque development characteristic of the at least one control fluid to determine if the fluid specimen has the target fiber content.

In some embodiments, measuring the initial torque development characteristic may comprise measuring torque versus time of the fluid specimen in a yield point rheometer at a condition of shear rate and temperature; and comparing the initial torque development characteristics may comprise comparing the measured torque versus time of the specimen to control curves of control fluids of known fiber content at the condition of shear rate and temperature to estimate the fiber content of the fluid specimen.

In some embodiments, the fluid specimen and the control fluid(s) may comprise a base fluid comprising a liquid carrier and an optional viscosifier, wherein the fluid specimen and the control fluids comprise the same base fluid comprising the same viscosifier (where present) and carrier liquid. In some embodiments, the viscosifier is linear. In some embodiments, the viscosifier is selected from polysaccharides and viscoelastic surfactants. In some embodiments, the viscosifier may be crosslinked and/or the method may further comprise decrosslinking the crosslinked viscosifier prior to measuring the yield point.

In some embodiments, the fiber has an aspect ratio higher than 6.

In some embodiments, the method may further comprise interpolating between curves of the initial torque development characteristic of the control fluids of different fiber content.

In some embodiments, the specified conditions may comprise temperature, rheometer, rheometer settings, base fluid composition, fiber composition, fiber aspect ratio and the like, including combinations thereof.

According to some embodiments herein, a system to determine fiber content of a fluid specimen, comprising a base fluid comprising a carrier liquid and an optional viscosifier, may comprise a yield point rheometer to measure an initial torque development characteristic of the fluid specimen at specified conditions; and a database of initial torque development characteristics of control fluids of known fiber content at the specified conditions for comparison with the measured initial torque development characteristic to estimate the fiber content of the fluid specimen.

In some embodiments of the system, the fluid specimen and the control fluids may comprise the same base fluid comprising the same viscosifier and carrier liquid.

In some embodiments of the system, the viscosifier may be linear. In some embodiments of the system, the viscosifier may be crosslinked. In some embodiments, the system may further comprise a reagent to decrosslink the crosslinked viscosifier prior to measuring the yield point. In some embodiments of the system, the viscosifier may be selected from polysaccharides and viscoelastic surfactants. In some embodiments of the system, the fiber may have an aspect ratio higher than 6. In some embodiments of the system, the specified conditions comprise temperature, rheometer, rheometer settings, base fluid composition, fiber composition, and fiber aspect ratio and the like, including combinations thereof.

Since the present method and system relate to physical properties, they are generally applicable to most fibers regardless of materials or dimensions. In some embodiments, the fiber may be selected from the group consisting of polylactic acid (PLA), polyglycolic acid (PGA), polyethylene terephthalate (PET), polyester, polyamide, polycaprolactam and polylactone, poly(butylene Succinate, polydioxanone, glass, ceramics, carbon (including carbon-based compounds), elements in metallic form, metal alloys, wool, basalt, acrylic, polyethylene, polypropylene, novoloid resin, polyphenylene sulfide, polyvinyl chloride, polyvinylidene chloride, polyurethane, polyvinyl alcohol, polybenzimidazole, polyhydroquinone-diimidazopyridine, poly(p-phenylene-2,6-benzobisoxazole), rayon, cotton, rubber, or a combination thereof.

In further embodiments, fiber may be selected from the group consisting of polylactic acid (PLA), polyester, polycaprolactam, polyamide, polyglycolic acid, polyterephthalate, cellulose, wool, basalt, glass, rubber, or a combination thereof.

In some embodiments, the fiber is present in the fiber-containing slurry in an amount of less than 5 vol %. All individual values and subranges from less than 5 vol % are included and disclosed herein. For example, the amount of fiber may be from 0.05 vol % to less than 5 vol %, or less than 1.5 vol %, or less than 1 vol %. The fiber may be present in an amount from 0.2 vol % to 1.5 vol %, or in an amount from 0.01 vol % to 0.5 vol %, or in an amount from 0.05 vol % to 0.5 vol %.

In further embodiments, the fiber may have a length from 1 to 50 mm, or more specifically from 1 to 10 mm, and a diameter of from 1 to 50 microns, or, more specifically from 1 to 20 microns. All values and subranges from 1 to 50 mm are included and disclosed herein. For example, the fiber length may be from a lower limit of 1, 3, 5, 7, 9, 19, 29 or 49 mm to any higher upper limit of 2, 4, 6, 8, 10, 20, 30 or 50 mm. The fiber length may range from 1 to 50 mm, or from 1 to 10 mm, or from 1 to 7 mm, or from 3 to 10 mm, or from 2 to 8 mm. All values from 1 to 50 microns are included and disclosed herein. For example, the fiber diameter may be from a lower limit of 1, 4, 8, 12, 16, 20, 30, 40, or 49 microns to an upper limit of 2, 6, 10, 14, 17, 22, 32, 42 or 50 microns. The fiber diameter may range from 1 to 50 microns, or from 10 to 50 microns, or from 1 to 15 microns, or from 2 to 17 microns.

In further embodiments, the fiber may have a length from 0.001 to 1 mm and a diameter of from 50 nanometers (nm) to 10 microns. All individual values from 0.001 to 1 mm are disclosed and included herein. For example, the fiber length may be from a lower limit of 0.001, 0.01, 0.1 or 0.9 mm to any higher upper limit of 0.009, 0.07, 0.5 or 1 mm. All individual values from 50 nanometers to 10 microns are included and disclosed herein. For example, the fiber diameter may range from a lower limit of 50, 60, 70, 80, 90, 100, or 500 nanometers to an upper limit of 500 nanometers, 1 micron, or 10 microns.

According to some embodiments herein, with reference to FIG. 2 a method 10 may begin with the preparation or other procurement of one or more reference slurries 12. In general, the characteristics of the reference slurries 12 should be selected so as close as possible to those of the likely test specimens in order to reduce the number and extent of confounding variables that may impact the torque development characteristics.

In some embodiments, a step 14 next involves measuring the torque development characteristics of one or a plurality of the reference slurries. For example, where the test specimen is expected to have a target fiber loading, it may be sufficient to measure the torque development characteristic of a single reference slurry containing the target fiber loading. On the other hand, in some embodiments it may be desirable to make multiple measurements to improve statistical confidence and/or measure (one or multiple times) a plurality of different fiber loadings in the reference slurries to expand the range of applicable fiber contents of the test sample(s) that may be determined.

The measurement of the torque development characteristics in some embodiments may involve using a yield point rheometer employing manufacturer protocols. Yield stress, also known as yield point, is a common rheological property that is characterized in other segments of the oilfield (cementing, drilling fluid, etc.), but it is an uncommon measurement applied to stimulation treatment fluids, e.g., fracturing fluids. According to some embodiments, the rapid and reliable measurement of fiber content in stimulation fluids containing fibers can benefit stimulation operators by confirming that proper fiber concentrations are being pumped, in the treatment fluids in which they are present, e.g., HiWAY, FiberFRAC, MaxCO3 Acid, StimMORE, PropGUARD, and PropNET stimulation fluids. Torque development characteristics can be measured quickly compared to waiting for filtered fiber samples to dry, and accurate such measures are sufficiently reliable and accurate.

Yield point rheometers, also sometimes called yield stress rheometers, are commercially available, for example, under the trade designations BROOKFIELD YR-1. In some embodiments the yield stress rheometer is of the rotational type wherein a vaned spindle is immersed in the test material and rotated at a low speed while observing any changes in the torque measured as the motor rotates faster than the spindle. In some embodiments, the ratio of the motor speed to the spindle remain constant; the measurement is the additional power required to maintain a prescribed speed as the vane rotates in the slurry medium. In some embodiments, the displacement of the test material by the spindle may be measured by deflection of a calibrated spring in the instrument. Thus, the shear stress measurement range may be a function of the size and shape of the spindle and the full scale torque of the calibrated spring.

In some embodiments, using a yield rheometer fitted with a vane attachment, the % Torque versus time curves may be created from known concentrations of fiber in step 14. Fluid specimens with unknown concentrations of fiber can be tested on the same type of yield rheometer using the same testing protocol in step 18, and the resulting % Torque versus time curves compared to the control curves in step 20 to determine the fiber concentration 22.

As used herein, the terms “treatment fluid” or “wellbore treatment fluid” are inclusive of “fracturing fluid” or “treatment slurry” and should be understood broadly. These may be or include a liquid, a solid, a gas, and combinations thereof, as will be appreciated by those skilled in the art. A treatment fluid may take the form of a solution, an emulsion, an energized fluid (including foam), slurry, or any other form as will be appreciated by those skilled in the art.

As used herein, “slurry” refers to an optionally flowable mixture of particles dispersed in a fluid carrier. The terms “flowable” or “pumpable” or “mixable” are used interchangeably herein and refer to a fluid or slurry that has either a yield stress or low-shear (511 s⁻¹) viscosity less than 1000 Pa and a dynamic apparent viscosity of less than 10 Pa-s (10,000 cP) at a shear rate 170 s⁻¹, where yield stress, low-shear viscosity and dynamic apparent viscosity are measured at a temperature of 25° C. unless another temperature is specified explicitly or in context of use.

“Viscosity” as used herein unless otherwise indicated refers to the apparent dynamic viscosity of a fluid at a temperature of 25° C. and shear rate of 170 s⁻¹. In some embodiments, the carrier fluid of the test (also called sample) and/or reference (also called control) fluids, may have a lower limit of apparent dynamic viscosity, determined at 170 s⁻¹ and 25° C., of at least about 1 mPa-s, or at least about 10 mPa-s, or at least about 25 mPa-s, or at least about 50 mPa-s, or at least about 75 mPa-s, or at least about 100 mPa-s, or at least about 150 mPa-s, or at least about 300 mPa-s, or at least about 500 mPa-s. In some embodiments, the fluid carrier has an upper limit of apparent dynamic viscosity, determined at 170 s⁻¹ and 25° C., of less than about 1000 mPa-s, or less than about 500 mPa-s, or less than about 300 mPa-s, or less than about 150 mPa-s, or less than about 100 mPa-s, or less than about 50 mPa-s. In an embodiment, the fluid phase viscosity ranges from any lower limit to any higher upper limit.

“Treatment fluid” or “fluid” (in context) refers to the entire treatment fluid, including any proppant, subproppant particles, liquid, gas etc. “Whole fluid,” “total fluid” and “base fluid” are used herein to refer to the fluid phase plus any subproppant particles dispersed therein, but exclusive of proppant particles. “Carrier,” “fluid phase” or “liquid phase” refer to the fluid or liquid that is present, which may comprise a continuous phase and optionally one or more discontinuous gas or liquid fluid phases dispersed in the continuous phase, including any solutes, thickeners or colloidal particles only, exclusive of other solid phase particles; reference to “water” in the slurry refers only to water and excludes any gas, liquid or solid particles, solutes, thickeners, colloidal particles, etc.; reference to “aqueous phase” refers to a carrier phase comprised predominantly of water, which may be a continuous or dispersed phase. As used herein the terms “liquid” or “liquid phase” encompasses both liquids per se and supercritical fluids, including any solutes dissolved therein.

The term “dispersion” means a mixture of one substance dispersed in another substance, and may include colloidal or non-colloidal systems. As used herein, “emulsion” generally means any system with one liquid phase dispersed in another immiscible liquid phase, and may apply to oil-in-water and water-in-oil emulsions. Invert emulsions refer to any water-in-oil emulsion in which oil is the continuous or external phase and water is the dispersed or internal phase.

The terms “energized fluid” and “foam” refer to a fluid which when subjected to a low pressure environment liberates or releases gas from solution or dispersion, for example, a liquid containing dissolved gases. Foams or energized fluids are stable mixtures of gases and liquids that form a two-phase system. Foam and energized fluids are generally described by their foam quality, i.e. the ratio of gas volume to the foam volume (fluid phase of the treatment fluid), i.e., the ratio of the gas volume to the sum of the gas plus liquid volumes). If the foam quality is between 52% and 95%, the energized fluid is usually called foam. Above 95%, foam is generally changed to mist. In the present patent application, the term “energized fluid” also encompasses foams and refers to any stable mixture of gas and liquid, regardless of the foam quality. Energized fluids comprise any of:

(a) Liquids that at bottom hole conditions of pressure and temperature are close to saturation with a species of gas. For example the liquid can be aqueous and the gas nitrogen or carbon dioxide. Associated with the liquid and gas species and temperature is a pressure called the bubble point, at which the liquid is fully saturated. At pressures below the bubble point, gas emerges from solution;
(b) Foams, consisting generally of a gas phase, an aqueous phase and a solid phase. At high pressures the foam quality is typically low (i.e., the non-saturated gas volume is low), but quality (and volume) rises as the pressure falls. Additionally, the aqueous phase may have originated as a solid material and once the gas phase is dissolved into the solid phase, the viscosity of solid material is decreased such that the solid material becomes a liquid; or
(c) Liquefied gases.

In some embodiments, the treatment fluid may include a continuous fluid phase, also referred to as an external phase, and a discontinuous phase(s), also referred to as an internal phase(s), which may be a fluid (liquid or gas) in the case of an emulsion, foam or energized fluid, or which may be a solid in the case of a slurry. The continuous fluid phase, also referred to herein as the carrier fluid or comprising the carrier fluid, may be any matter that is substantially continuous under a given condition. Examples of the continuous fluid phase include, but are not limited to, water, hydrocarbon, gas (e.g., nitrogen or methane), liquefied gas (e.g., propane, butane, or the like), etc., which may include solutes, e.g. the fluid phase may be a brine, and/or may include a brine or other solution(s). In some embodiments, the fluid phase(s) may optionally include a viscosifying and/or yield point agent and/or a portion of the total amount of viscosifying and/or yield point agent present. In some embodiments, the fluid may include friction reducers such as polyacrylamides. Some non-limiting examples of the fluid phase(s) include hydratable gels and mixtures of hydratable gels (e.g. gels containing polysaccharides such as guars and their derivatives, xanthan and diutan and their derivatives, hydratable cellulose derivatives such as hydroxyethylcellulose, carboxymethylcellulose and others, polyvinyl alcohol and its derivatives, other hydratable polymers, colloids, etc.), a cross-linked hydratable gel, a viscosified acid (e.g. gel-based), an emulsified acid (e.g. oil outer phase), an energized fluid (e.g., an N₂ or CO₂ based foam), a viscoelastic surfactant (VES) viscosified fluid, and an oil-based fluid including a gelled, foamed, or otherwise viscosified oil.

“Proppant” (also called gravel) refers to particulates that are used in well work-overs and treatments, such as hydraulic fracturing operations, to hold fractures open following the treatment. In some embodiments, the treatment fluid may comprise proppant which may have a weight average mean particle size greater than or equal to about 100 microns, e.g., 140 mesh particles correspond to a size of 105 microns. In further embodiments, the treatment fluid may comprise, in addition to fiber and/or proppant, particles or aggregates made from particles with size from 0.001 to 1 mm. All individual values from 0.001 to 1 mm are disclosed and included herein. For example, the particle size may be from a lower limit of 0.001, 0.01, 0.1 or 0.9 mm to an upper limit of 0.009, 0.07, 0.5 or 1 mm. In some embodiments where proppant or other non-fiber particles are present or absent in the test specimen or sample, they may be likewise present or absent in the control or reference fluids. In some embodiments, however, the presence or absence of non-fiber proppants and/or particles may not have much influence on the initial torque development characteristics of the fluids containing them, in which case it is contemplated herein that the initial torque development characteristics of test fluids containing solids other than fibers may be compared to reference fluids free of solids, or vice versa.

The proppant, when present, can be naturally occurring materials, such as sand grains. The proppant, when present, can also be man-made or specially engineered, such as coated (including resin-coated) sand, modulus of various nuts, high-strength ceramic materials like sintered bauxite, etc.

In embodiments, the fluid may include leakoff control agents, such as, for example, latex dispersions, water soluble polymers, submicron particulates, particulates with an aspect ratio higher than 1, or higher than 6, combinations thereof and the like, such as, for example, crosslinked polyvinyl alcohol microgel. In some embodiments, the viscosifier(s) which may be present in the fluid may serve a dual role as a fluid loss agent. The fluid loss agent can be, for example, a latex dispersion of polyvinylidene chloride, polyvinyl acetate, polystyrene-co-butadiene; a water soluble polymer such as hydroxyethylcellulose (HEC), guar, copolymers of polyacrylamide and their derivatives; particulate fluid loss control agents in the size range of 30 nm to 1 micron, such as γ-alumina, colloidal silica, CaCO3, SiO2, bentonite etc.; particulates with different shapes such as glass fibers, flocs, flakes, films; and any combination thereof or the like. Fluid loss agents can if desired also include or be used in combination with acrylamido-methyl-propane sulfonate polymer (AMPS). In an embodiment, the leak-off control agent comprises a reactive solid selected from ground quartz, oil soluble resin, degradable rock salt, clay, zeolite or the like. In other embodiments, the leak-off control agent comprises one or more of magnesium hydroxide, magnesium carbonate, magnesium calcium carbonate, calcium carbonate, aluminum hydroxide, calcium oxalate, calcium phosphate, aluminum metaphosphate, sodium zinc potassium polyphosphate glass, and sodium calcium magnesium polyphosphate glass, polylactic acid or the like. The treatment fluid may also contain colloidal particles, such as, for example, colloidal silica, which may function as a loss control agent, gellant and/or thickener.

Accordingly, the present invention provides the following embodiments:

E1. A method to determine fiber content of a fluid specimen, comprising: measuring an initial torque development characteristic of the fluid specimen at specified conditions; and comparing the measured initial torque development characteristic of the specimen to initial torque development characteristics of control fluids of known fiber content at the specified conditions to estimate the fiber content of the fluid specimen.
E2. A method to determine fiber content of a fluid specimen, comprising: measuring initial torque development characteristics of a plurality of control fluids of known fiber content on a rheometer at specified conditions; measuring the initial torque development characteristic of the fluid specimen at the specified conditions; comparing the measured initial torque development characteristic of the specimen to the measured initial torque development characteristics of the control fluids to estimate the fiber content of the fluid specimen.
E3. A method to determine fiber content of a fluid specimen, comprising: measuring an initial torque development characteristic, of at least one control fluid having a target fiber content, on a rheometer at specified conditions; mixing a base fluid with a sufficient proportion of the fiber for obtaining a mixture with the target fiber content; sampling the mixture to obtain the fluid specimen; measuring the initial torque development characteristic of the fluid specimen at the specified conditions; and comparing the measured initial torque development characteristic of the specimen to the measured initial torque development characteristic of the at least one control fluid to determine if the fluid specimen has the target fiber content.
E4. The method of any one of embodiments E1 to E3, wherein measuring the initial torque development characteristic comprises measuring torque versus time of the fluid specimen in a yield point rheometer at a condition of shear rate and temperature; and wherein comparing the initial torque development characteristic comprises comparing the measured torque versus time of the specimen to control curves of control fluids of known fiber content at the condition of shear rate and temperature.
E5. The method of any one of embodiments E1 to E4, wherein the fluid specimen and the control fluids comprise the same base fluid comprising the same viscosifier and carrier liquid.
E6. The method of embodiment E5, wherein the viscosifier is linear.
E7. The method of embodiment E5, wherein the viscosifier is crosslinked.
E8. The method of embodiment E7, further comprising decrosslinking the crosslinked viscosifier prior to measuring the initial torque development characteristic.
E9. The method of any one of embodiments E5 to E8, wherein the viscosifier is selected from polysaccharides and viscoelastic surfactants.
E10. The method of any one of embodiments E1 to E9, wherein the fiber has an aspect ratio higher than 6.
E11. The method of any one of embodiments E1 to E10, further comprising interpolating between curves of the initial torque development characteristic of the control fluids of different fiber content.
E12. The method of any one of embodiments E1 to E11, wherein the specified conditions comprise temperature, rheometer, rheometer settings, base fluid composition, fiber composition, fiber aspect ratio, or a combination thereof.
E13. The method of any one of embodiments E1 to E12, wherein the initial torque development characteristic comprises a curve of the torque versus time obtained from a yield point rheometer.
E14. The method of any one of embodiments E1 to E12, wherein the initial torque development characteristic comprises a maximum value of the torque measured from a yield point rheometer.
E15. The method of any one of embodiments E1 to E12, wherein the initial torque development characteristic comprises a slope of the torque versus time obtained from a yield point rheometer.
E16. The method of any one of embodiments E1 to E12, wherein the initial torque development characteristic comprises a value of the torque measured at a specified time from a yield point rheometer.
E17. The method of embodiment E16, wherein the specified time is from 2 to 15 seconds, or from 3 to 12 seconds, or from 5 to 10 seconds.
E18. The method of embodiment E17 or embodiment E18, further comprising generating an equation for the fiber content versus torque measured at the specified time from the control fluids or the at least one control fluid, and calculating the fiber content of the fluid specimen from the generated equation and the torque measured at the specified time for the fluid specimen.
E19. A system to determine fiber content of a fluid specimen comprising a base fluid comprising a carrier liquid and an optional viscosifier, comprising: a yield point rheometer to measure an initial torque development characteristic of the fluid specimen at specified conditions; and a database of initial torque development characteristics of control fluids of known fiber content at the specified conditions for comparison with the measured initial torque development characteristic to estimate the fiber content of the fluid specimen.
E20. The system of embodiment E19, wherein the measurement of the initial torque development characteristic comprises measuring torque versus time of the fluid specimen in a yield point rheometer at a condition of shear rate and temperature; and wherein comparing the initial torque development characteristic comprises comparing the measured torque versus time of the specimen to control curves of control fluids of known fiber content at the condition of shear rate and temperature.
E21. The system of embodiments E19 or embodiment E20, wherein the fluid specimen and the control fluids comprise the same base fluid comprising the same viscosifier and carrier liquid.
E22. The system of embodiment E21, wherein the viscosifier is linear.
E23. The system of embodiment E21, wherein the viscosifier is crosslinked.
E24. The system of embodiment E23, further comprising a reagent to decrosslink the crosslinked viscosifier prior to measuring the initial torque development characteristic.
E25. The system of any one of embodiments E19 to E24, wherein the viscosifier is selected from polysaccharides and viscoelastic surfactants.
E26. The system of any one of embodiments E19 to E25, wherein the fiber has an aspect ratio higher than 6.
E27. The system of any one of embodiments E19 to E26, wherein the specified conditions comprise temperature, rheometer, rheometer settings, base fluid composition, fiber composition, fiber aspect ratio, or a combination thereof.
E28. The system of any one of embodiments E19 to E27, wherein the initial torque development characteristic comprises a curve of the torque versus time obtained from a yield point rheometer.
E29. The system of any one of embodiments E19 to E28, wherein the initial torque development characteristic comprises a maximum value of the torque measured from a yield point rheometer.
E30. The system of any one of embodiments E19 to E29, wherein the initial torque development characteristic comprises a slope of the torque versus time obtained from a yield point rheometer.
E31. The system of any one of embodiments E19 to E30, wherein the initial torque development characteristic comprises a value of the torque measured at a specified time from a yield point rheometer.
E32. The system of embodiment E31, wherein the specified time is from 2 to 15 seconds, or from 3 to 12 seconds, or from 5 to 10 seconds.
E33. The system of embodiment E31 or embodiment E32, wherein the database comprises an equation for the fiber content versus torque measured at the specified time generated from the control fluids to calculate the fiber content of the fluid specimen from the generated equation and the torque measured at the specified time for the fluid specimen.

### EXAMPLES

In the following examples, all tests were performed at ambient conditions (room temperature, atmospheric pressure).

### Example 1 (Comparative)

attempt to characterize fiber concentration using Couette type rheometer. In this example, polylactic acid (PLA) fibers were added in varying concentrations to a typical linear aqueous gel fluid prepared with tap water and composed of 3 g/L guar based on the volume of clean fluid (25 lb guar per 1000 gal of clean fluid, 25 ppt). The viscosity was measured with a Couette-style CHANDLER 3500 rheometer at 300 RPM (shear rate: 511 sec⁻¹) equipped with an R1 rotor, a B1 bob and an F1 spring configuration (R1B1F1). Fiber concentrations were 0 (no fiber added), 3 g/L (25 ppt), 6 g/L (50 ppt), 9 g/L (75 ppt) and 12 g/L (100 ppt).

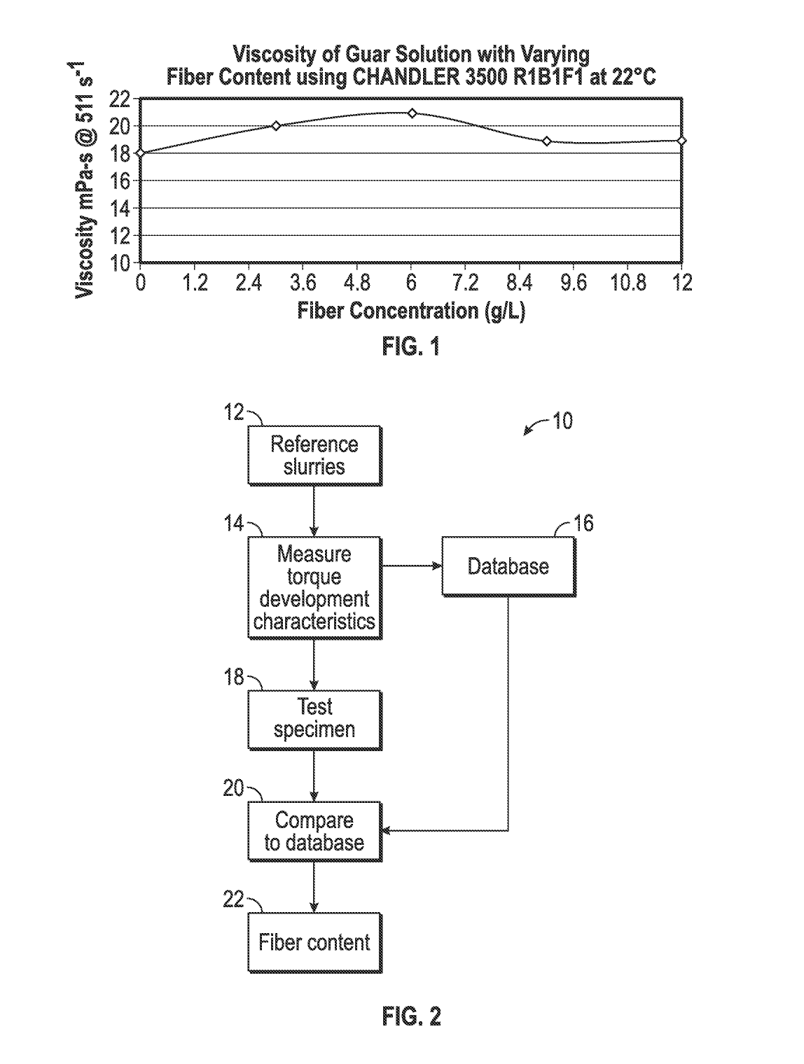

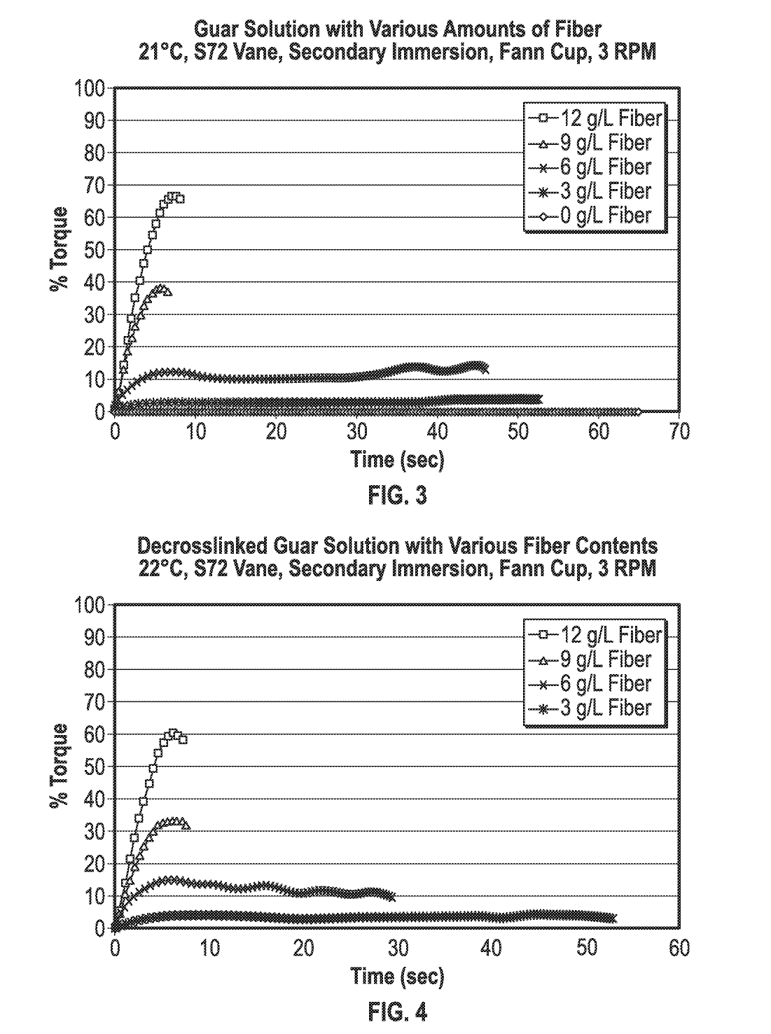

The data shown in FIG. 1 failed to produce any useable result, and are typical of past attempts to characterize fiber concentration by using Couette type rheometers, e.g., bob and rotor style rheometers such as the FANN 35, FANN 50, CHANDLER 3500, CHANDLER 5550, etc. Without fiber the rheometer gave a reading of 18 mPa-s (18 cP). When fibers were added to the fluid, the slurry visibly appeared to begin to thicken and become “chunky”, with a consistency like that of pudding or gelatin. However, despite the fiber concentration increasing from 0 to 12 g/L (100 ppt), there is hardly any response in the instrument. Based on visual appearance, the viscosity was expected to have risen by hundreds of mPa-s (100's of cP); however, from 0 to 6 g/L (50 ppt) there was only a slight increase in viscosity of 3 mPa-s (3 cP), which was hardly remarkable and gave little to no indication in any significant change in rheology. As the fiber concentration increased further, the viscosity decreased back to essentially the baseline conditions. Although applicants are not tied to any theory, this behavior has been attributed to the fibers aligning themselves in the fluid as it passes through the narrow gap between the bob and rotor.

Other methods of measuring fibers in stimulation fluids include: (1) Mass balance: physically counting the mass of fiber added per unit time, which is then correlated to a particular flowrate and total fluid volume pumped); and (2) Filtration/Dry Weight Measurement: A known volume of the fiber-laden slurry is collected and the fibers are physically separated and filtered from the fluid, washed to remove any chemical residue, dried and finally weighed, where the weight of fibers collected is compared to the initial volume of slurry collected to determine the concentration. However, none of these methods provide a reliable, fast, and convenient method of determining fiber concentrations in stimulation fluids.

### Example 2

characterizing fiber concentration in a linear gel using a yield stress instrument. In this and the following examples, a Brookfield YR-1 model with an S72 vane assembly was used to evaluate the rheology of the same fiber-laden fluids of Example 1, with the spindle inserted to reach the secondary immersion mark according to the protocol described in the BROOKFIELD YR-1 RHEOMETER Operating Instructions, Manual No. M/02-215. As shown in Error! Reference source not found. 3, clear distinctions can be made between the various fiber-laden fluids. As the fiber concentration was increased, the fluid exerted a greater resistance that required the motor of the rheometer to develop a higher torque rating to maintain the same rotational velocity. The data in Error! Reference source not found. 1 demonstrated that the rheometer could detect fiber loading differences in a linear gel system.

### Example 3

characterizing fiber concentration in a de-crosslinked gel using a yield stress instrument. In the stimulation industry it is more common to use metal cross-linked fluid systems that contain fiber, e.g. HiWAY, FiberFRAC. In this example the procedure of Example 2 was repeated using a cross-linked fluid that had been de-crosslinked chemically by pH adjustment with acid addition. The data in Error! Reference source not found. demonstrate that a cross-linked fluid can be readily chemically de-crosslinked (e.g. pH adjustment) and then the fluid easily measured with a yield rheometer as with a linear gel. As in Example 2, the concentration of fibers could easily be discerned, and higher concentrations of fibers led to higher torque measurements.

### Example 4

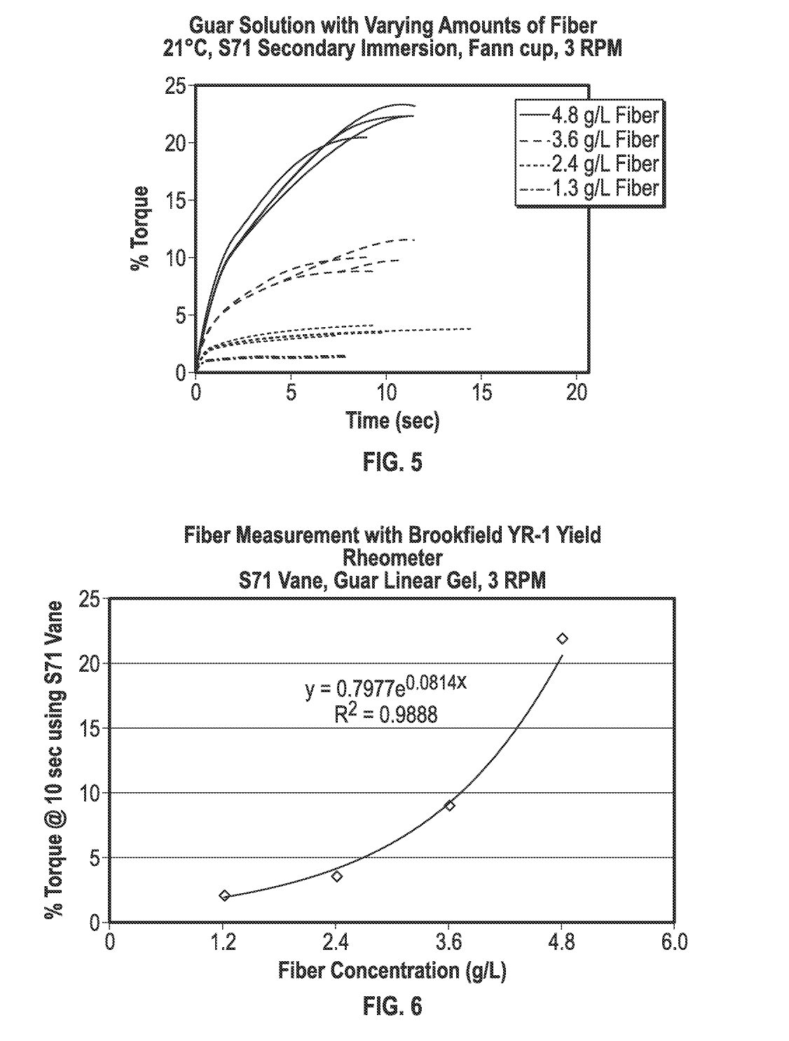

generating reference curves for curve matching. In this example, the testing of the reference samples was repeated several times using the procedure of Example 2 (linear gel, 21° C., secondary immersion, Fann cup, 3 rpm). The reference curves are plotted in FIG. 5. Curve matching between test and reference samples generally involves observing the maximum torque readings and the time it takes to reach these values. By measuring a test sample, one can compare the curve of the test sample to those of the reference samples to determine the approximate fiber content of the test sample, e.g., if the test sample curve closely follows the 4.8 g/L reference sample curves, one can conclude that the test sample contains approximately 4.8 g/L fiber, or if the test sample curve is generally halfway between the 4.8 and 6 g/L curves, that the test sample contains approximately 5.4 g/L fiber.

### Example 5

determining the fiber loading in a particular sample using 10-second torque readings. In this example, a correlation was generated between the fiber content and the maximum percent torque reading reached at a certain time within the test, using the testing procedure and fluids of Examples 4. In this case 10 seconds was selected. The data for the reference fluids obtained after 10 seconds of measurement at 3 RPM using an S71 vane with a linear gel fluid are presented in Table 1.

TABLE 1
% Torque at 10 seconds vs. Fiber Concentration

| Fiber Loading, g/L (ppt) | % Torque |
|---|---|
| 10 | 2 |
| 20 | 3.5 |
| 30 | 9 |
| 40 | 22 |

Plotting the data from Table 1 generates the chart shown in FIG. 6, which can be roughly fit with the exponential equation y=0.7977e**0.0814. Using the chart or the equation, one can then estimate or calculate the test sample fiber content for a similar gel fluid at the same test conditions based on the 10 second reading, e.g., a test sample reading of 10% torque at seconds indicates approximately 3.7 g/L fiber, a reading of 20% torque approximately 4.8 g/L fiber, etc.

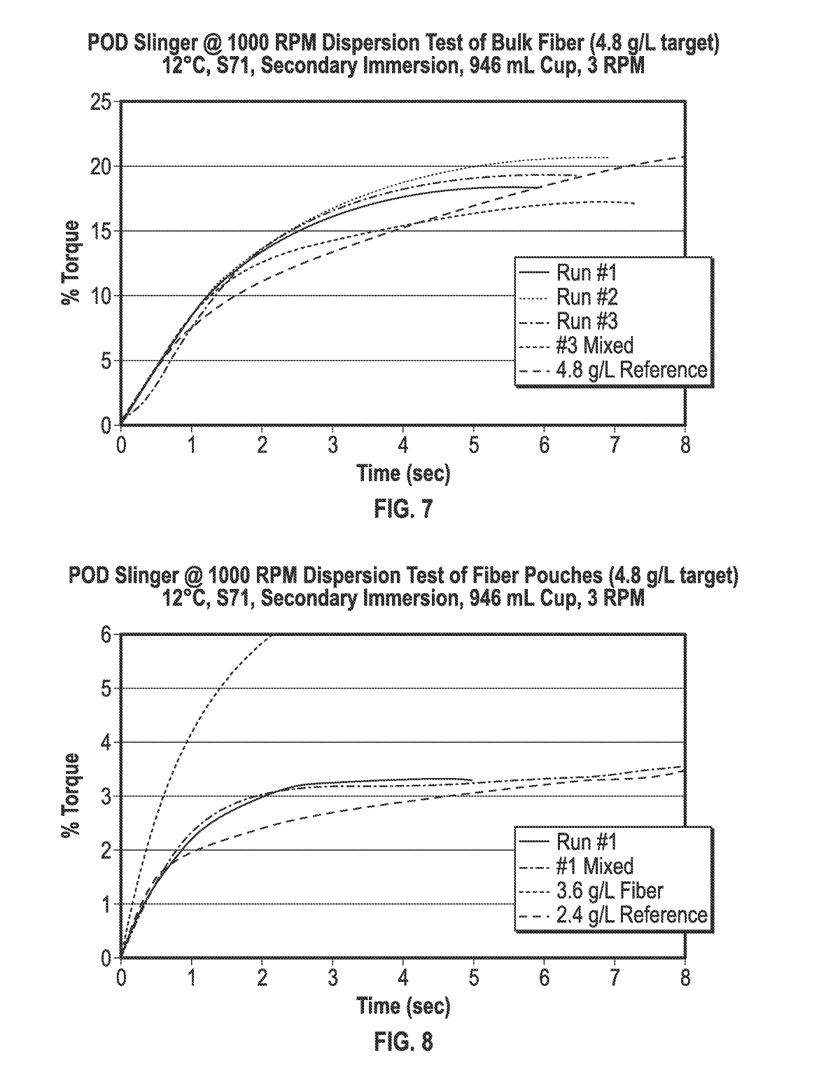

Example 6: curve matching in a field experiment. Fiber was added at 4.8 g/L (40 ppt) to a large mixer called a “POD slinger.” Although the fiber was added at 4.8 g/L, it needed to be determined whether or not the fluid was fully homogenized. Using the reference curves that had been previously developed for the particular fluids and fibers, and the same sample testing protocol, test sample data for three samples and a mixture thereof were superimposed on top of the reference sample data, as shown in FIG. 7. The three samples taken during the test reached a maximum torque % that was closest to the 4.8 g/L reference curve. Whether comparing the curves per se, extrapolating the data to the 10 second mark, or picking the maximum % torque, these samples are all roughly close to the 18-21% torque values, closest to the 4.8 g/L reference samples. Therefore, with this method of fiber addition, it can be confirmed that the actual amount of fiber homogeneously distributed in the fluid was quite close to the amount of fiber dosed with very little variation between samples.

### Example 7

curve matching in another field experiment. By contrast, a different delivery method, using fiber pouches for the same fiber and fluid as in Example 5, was tested. The reference and sample data are plotted in FIG. 8. Although the fiber was similarly dosed at 4.8 g/L, the test sample curve was similar to the 2.4 g/L reference curve. Thus, the amount of fiber detected in this fluid sample was approximately half of the target concentration.

While the embodiments have been illustrated and described in detail in the drawings and foregoing description, the same is to be considered as illustrative and not restrictive in character, it being understood that only some embodiments have been shown and described and that all changes and modifications that come within the spirit of the embodiments are desired to be protected. It should be understood that while the use of words such as ideally, desirably, preferable, preferably, preferred, more preferred or exemplary utilized in the description above indicate that the feature so described may be more desirable or characteristic, nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

We claim:

1. A method to determine fiber content of a fluid specimen, comprising:
measuring an initial torque development characteristic of the fluid specimen at specified conditions;
comparing the measured initial torque development characteristic of the specimen to initial torque development characteristics of control fluids of known fiber content at the specified conditions to estimate the fiber content of the fluid specimen.

2. The method of claim 1, wherein measuring the initial torque development characteristic comprises measuring torque versus time of the fluid specimen in a yield point rheometer at a condition of shear rate and temperature; and wherein comparing the initial torque development characteristic comprises comparing the measured torque versus time of the specimen to control curves of control fluids of known fiber content at the condition of shear rate and temperature.

3. The method of claim 1, wherein the fluid specimen and the control fluids comprise the same base fluid comprising the same viscosifier and carrier liquid.

4. The method of claim 3, wherein the viscosifier is linear.

5. The method of claim 3, wherein the viscosifier is crosslinked.

6. The method of claim 5, further comprising decrosslinking the crosslinked viscosifier prior to measuring the initial torque development characteristic.

7. The method of claim 3, wherein the viscosifier is selected from polysaccharides, polyacrylamides and viscoelastic surfactants.

8. The method of claim 1, wherein the fiber has an aspect ratio higher than 6.

9. The method of claim 1, further comprising interpolating between curves of the initial torque development characteristic of the control fluids of different fiber content.

10. The method of claim 1, wherein the specified conditions comprise temperature, rheometer, rheometer settings, base fluid composition, fiber composition, fiber aspect ratio, or a combination thereof.

11. A method to determine fiber content of a fluid specimen, comprising:
measuring initial torque development characteristics of a plurality of control fluids of known fiber content on a rheometer at specified conditions;
measuring the initial torque development characteristic of the fluid specimen at the specified conditions;
comparing the measured initial torque development characteristic of the specimen to the measured initial torque development characteristics of the control fluids to estimate the fiber content of the fluid specimen.

12. The method of claim 11, wherein the fluid specimen and the control fluids comprise the same base fluid comprising the same viscosifier and carrier liquid.

13. The method of claim 12, wherein the viscosifier is crosslinked and further comprising decrosslinking the crosslinked viscosifier prior to measuring the initial torque development characteristic.

14. The method of claim 11, further comprising interpolating between the initial torque development characteristic of the control fluids, wherein the initial torque development characteristic comprises a curve of the torque versus time obtained from a yield point rheometer.

15. The method of claim 11, wherein the specified conditions comprise temperature, rheometer, rheometer settings, base fluid composition, fiber composition, and fiber aspect ratio.

16. A method to determine fiber content of a fluid specimen, comprising:
measuring an initial torque development characteristic, of at least one control fluid having a target fiber content, on a rheometer at specified conditions;
mixing a base fluid with a sufficient proportion of the fiber for obtaining a mixture with the target fiber content;
sampling the mixture to obtain the fluid specimen;
measuring the initial torque development characteristic of the fluid specimen at the specified conditions; and
comparing the measured initial torque development characteristic of the specimen to the measured initial torque development characteristic of the at least one control fluid to determine if the fluid specimen has the target fiber content.

17. A system to determine fiber content of a fluid specimen comprising a base fluid comprising a carrier liquid and an optional viscosifier, comprising:
a yield point rheometer to measure an initial torque development characteristic of the fluid specimen at specified conditions; and
a database of initial torque development characteristics of control fluids of known fiber content at the specified conditions for comparison with the measured initial torque development characteristic to estimate the fiber content of the fluid specimen.

18. The system of claim 17, wherein the fluid specimen and the control fluids comprise the same base fluid comprising the same viscosifier and carrier liquid.

19. The system of claim 18, wherein the viscosifier is linear.

20. The system of claim 18, wherein the viscosifier is crosslinked.

21. The system of claim 20, further comprising a reagent to decrosslink the crosslinked viscosifier prior to measuring the initial torque development characteristic.

22. The system of claim 18, wherein the viscosifier is selected from polysaccharides and viscoelastic surfactants.

23. The system of claim 18, wherein the fiber has an aspect ratio higher than 6.

24. The system of claim 17, wherein the specified conditions comprise temperature, rheometer, rheometer settings, base fluid composition, fiber composition, and fiber aspect ratio, and wherein the initial torque development characteristic comprises torque versus time.
